(19) United States
(12) Patent Application Publication
(10) Pub. No.: US 2004/0060602 A1
(43) Pub. Date: Apr. 1, 2004

(54) Water diversion systems and methods

(75) Inventors: Stephen M. Mullins, Lakewood, CO (US); Mark E. Richers, Brighton, CO (US); Robin Williams, Denver, CO (US)

Correspondence Address: GAMBRO, INC, PATENT DEPARTMENT, 10810 W COLLINS AVE, LAKEWOOD, CO, 80215, US

(73) Assignee: Gambro, Inc., Lakewood, CO

(21) Appl. No.: 10/615,542

(22) Filed: Jul. 7, 2003

Related U.S. Application Data
(60) Provisional application No. 60/393,962, filed on Jul. 5, 2002.

(51) Int. Cl. F16K 37/00

(52) U.S. Cl. 137/551

(57) ABSTRACT

Systems and/or methods divert a fluid that has reached a preset alarm limit from reaching the point of use. The system may include a valve control unit; and a hydraulic unit operably connected to the valve control unit. The hydraulic unit may have first and second valves and plumbing pieces to connect the first and second valves to each other and the fluid system; the first valve being a normally closed valve that directs water from the fluid system to drain when energized; the second valve is a normally open valve that will turn off flow from the fluid system to the pure water distribution system. The methods may include flowing a fluid through a fluid system which includes a flow control system for preventing a fluid that has reached preset alarm limits from reaching the point of use; sensing when the fluid has reached the preset alarm limits; and signaling the opening of the normally closed valve; and the closing of the normally open valve to divert the fluid from the point of use to a drain.

This application claims the benefit of 60/393,962, filed Jul. 5, 2002.

### INTRODUCTION

The present invention relates generally to fluid flow control systems, and more particularly involves a two-part system including a hydraulic part and an electronic control part, the electronic control part being operably connected to the hydraulic part to control flow therethrough. This invention further presents particular advantages in medical and like high quality purified water supply systems such as in providing for the supply of purified water to a dialysis machine system while substantially limiting the risk of sub-standard quality purified water flowing to the dialysis machines and hence the dialysis patients.

### BACKGROUND

Fluid flow control systems have conventionally used sensors and valves in a variety of combinations and for various purposes. Sub-standard quality sensors are used to signal, often through an alarm when a fluid has reached a pre-selected characteristic level. An example of a fluid system which could benefit from higher standards of control is a purified water system. Purified water systems may involve numerous types of purification including for example, filtration, ultrafiltration, chemical treatment, irradiation, reverse osmosis (RO) and/or deionization (DI), inter alia. Among the higher quality purified water systems, most if not all of these purification processes/steps will be included as part of the water purification process, particularly including RO and/or DI.

There are presently a variety of industrial and medical devices and associated procedures that require the use of purified water. A prominent example is found in medical dialysis. In such dialysis procedures generally, including hemodialysis, hemofiltration and hemodiafiltration processes, blood to be dialyzed is taken from a patient and passed through a dialyzer where the blood is cleaned of its impurities and then returned to the patient. Contemporary dialyzers are ordinarily of a membrane type in which the blood may be passed along one side of the membrane, while in the most common types of dialysis, another liquid, often called dialysate, may be passed along the opposite side of the membrane. This process is conceptually the same in plate, hollow fiber and coil dialyzers. Ideally, impurities in the blood pass from the blood through the membrane and into the liquid dialysate. The liquid dialysate carrying these impurities then flows out of the dialyzer and is usually passed through a dialysis control monitor or machine to a drain. Some types of dialysis also provide for the dialysate to pass some materials therefrom into the blood through the membrane. Alternatively, such materials may be passed in a replacement liquid to the patient, the replacement liquid being passable with the blood through the dialyzer, or otherwise often being infused directly into the blood returning to the patient. The materials passed to the blood and patient may be desirable or beneficial agents, and/or in an undesirable situation they may be less than beneficial or even potentially harmful.

The dialysate and replacement liquids are both generally made from purified water in preferably controlled processes. Moreover various additive solutions and/or powders are often mixed into the purified water to create respective liquid solutions that may be and often are usually substantially isotonic to blood and include the desirable agents to be passed to the blood and patient. This mixing of additives with purified water may be effected in a centralized manner for distribution to one or more machines, or typically it may be performed at and/or by each discrete dialysis machine (also known as a monitor) during each dialysis session. This process is often referred to as on-line dialysate or replacement liquid preparation. A centralized, substantially continuous supply of purified water may then preferably be presented to either the central mixing system or to one or more of such on-line dialysis machines in a particular setting such as a hospital or a dialysis clinic for the preparation of these respective liquids during operation.

In a centralized water supply system such as this, it is common to provide a centralized purification arrangement including a reverse osmosis (R/O) apparatus or unit and/or a de-ionization (DI) apparatus or unit among other purification devices, such as carbon and/or mechanical filters and/or chemical treatment devices such as water softeners. There may also be additional water treatment for the removal of bacteria and/or endotoxins or the addition of or subjection to electromagnetic waves, e.g., ultraviolet light for the inactivation or destruction of such pathogens. In any event, the R/O or DI unit can establish the last purification step in the purification arrangement which, as is known in the art, then provides output purified water to medically acceptable and/or otherwise preferable or desirable quality or like standards. Though RO or DI may establish a near end step in purification, Ultraviolet (UV) (or other electromagnetic wave) irradiation and/or Ultrafiltration (UF) (for endotoxin removal, inter alia) methods/devices may be or in some instances must be disposed after the RO and/or DI processes. Indeed, UF often comes after UV and DI.

In any event, as mentioned above, this purified water may then be delivered in a typical dialysis setting to one or a plurality of dialysis machines, preferably through short branch connections emanating from a main or central supply line. The central supply line may then provide for the flow of any unused water to a drain or it may form a circuit by feeding back into one or more of the purification devices (such as the R/O unit) for re-purification and/or to other units (such as a central storage tank) and then/thereby provide for recirculation out to and through the central supply line circuit. Note, within some R/O devices/sub-systems, there may also be some valve arrangements which may provide for diverting some water to a drain system.

Other industrial water usage machines and water supply circuits may also have similar limitations. Such systems may include pharmaceutical preparation processes and/or electronic device (e.g., microchip) manufacturing processes, and/or potable water distribution systems. Thus, any system which may take advantage of fluid diversion upon the sensing of a particular pre-determined parameter may be used in/with the present invention.

Hence, a need exists for providing for a safe communication of fluid from a source to point of use devices, like dialysis machines; and more particularly to the restriction of a supply of fluid to the point of use machines if the fluid fails to meet a particular parameter or characteristic. Thus, if in a purified water supply system, the water fails to meet a purification standard, desirable methods or systems may be provided to prevent the failed water from reaching a point of use such one or more dialysis machines, and/or prevent reaching a patient. It is toward this and related aims that the present invention is directed.

### BRIEF SUMMARY OF THE INVENTION

The system and method of the present invention provide for preventing a fluid, for an example, deionized (DI) water, that has characteristics which have reached preset alarm limits from traveling to a point of use. The configuration may be connectable to (or include) a water quality monitor such as a resistivity or conductivity monitor as known in the art. In some embodiments, the present invention may make use of alarm circuitry separate from, or alternatively, may use an alarm signal issued as part of an art-supplied monitor for activation of the valve control circuitry. In one application, this system prevents sub-standard quality DI water from reaching the point of use. In such an application, this system may be used in water treatment systems for dialysis; however, it may be used in other water or other fluid systems in which a sensor-initiated diversion of fluid flow is desired. Another such example may be potable water treated for public consumption.

The present system may in one embodiment be a free-standing valve system that is adapted to receive input from a separate (or included) detection unit (e.g., a quality, conductivity or other fluid parameter detection device) and then divert the sub-standard fluid to drain or otherwise away from the normal point or points of use. The present invention may also and/or alternatively include two units, for example, a hydraulic unit and a primarily electronic valve control unit. The hydraulic unit (HU) may include two valves and plumbing pieces to connect them to each other and to the water system. A first valve which may also be referred to as a drain valve may be a normally closed valve that directs water from the water system to drain when energized. The second valve which may alternatively be referred to as a “to loop” valve may be a normally open valve that when triggered will turn off flow from the water system to the pure water distribution system. These valves may be named differently depending on the water system configuration and system schematic. Alternative normally open and normally closed valve configurations may also be used with circuitry to trigger the valves into the desired positions during use (e.g., two normally closed valves may be used with the “to loop” valve triggered to the open position at initiation of use, or two normally open valves may be used with the drain valve triggered to closed position at initiation of operation until a divert condition is detected.

The second unit, a valve control unit (VCU) may include circuitry for valve activation, connection terminals, AC power connection and LED indicators for the user. The VCU may also include or be connected to the quality sensor which initiates the triggering of valve control.

As noted, systems of the present invention may be highly beneficial in purified water supply systems such as in medical applications like dialysis, or may also be useful in pharmaceutical preparation or electronics manufacturing or other water supply processes.

These and other aspects of the current invention will become clearer from the description of preferred embodiments considered in conjunction with the attached drawings which are described briefly below.

### BRIEF DESCRIPTION OF THE DRAWINGS

In the drawings:

FIG. 1 is a schematic view of a purified water supply/distribution system in which the fluid flow control system of the present invention is shown incorporated;

FIG. 2 is a schematic view of a flow control system according to the present invention;

FIG. 3 is an enlarged schematic view of a flow control sub-system according to the present invention, shown with one alternative embodiment of electrical circuitry;

FIG. 4 is a schematic view of a flow control system showing a detailed alternative embodiment of the present invention;

FIG. 5 is a schematic view of an alternative electrical connection system for use with/in the present invention;

FIG. 6 is an enlarged schematic view of a flow control sub-system like that shown in FIG. 3, shown with another alternative embodiment of electrical circuitry; and,

FIG. 7 is a schematic view of an alternative electrical connection system for use with/in the present invention with another alternative embodiment of electrical circuitry like that shown in FIG. 6.

### DETAILED DESCRIPTION

The present systems and methods provide for preventing a fluid such as deionized (DI) water which has reached, surpassed and/or fallen below a preset alarm limit from reaching the point of use. In one embodiment the system may use two two-way valves positioned to provide flow in a normal use direction flowing from a source to a point of use, the two-way valves being triggerable to alternatively provide a waste or drain flow direction to isolate the fluid flow from the point of use.

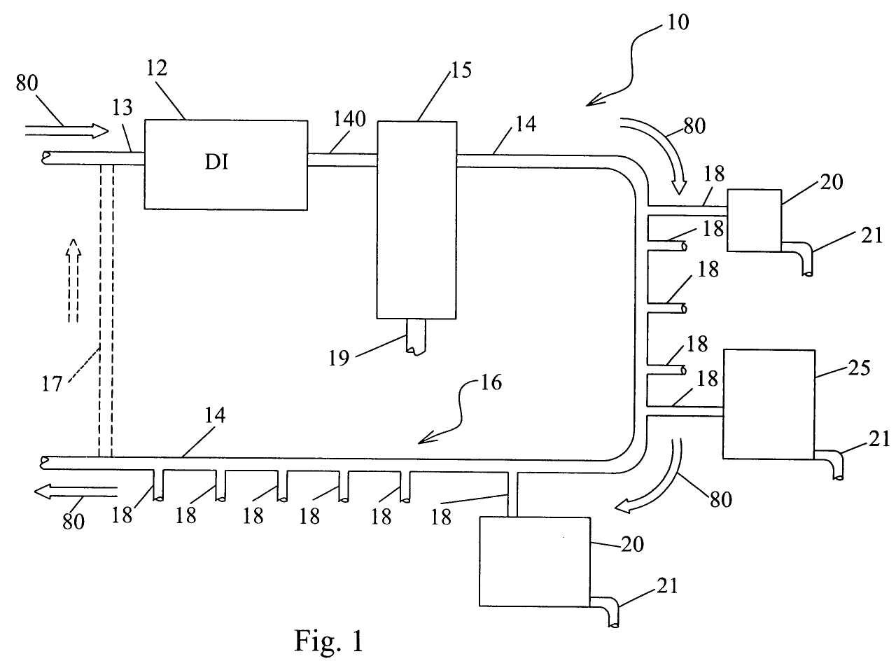

A fluid supply system 10 is shown in FIG. 1 which in one embodiment includes a fluid treatment or purifying unit 12 which feeds treated fluid either directly (not shown) into an outlet fluid supply line 14 or indirectly to line 14 via an intervening flow control system 15 (FIG. 1) which is connected to unit 12 via a connecting line 140. Treatment unit 12 may be a water purification unit (or units) such as an ultrafiltration (UF), or an ultraviolet (UV) irradiation, or a reverse osmosis (R/O) or de-ionization (DI) unit 12, and either of these or other types of treatment units may be considered here even if DI is described as the example in various portions of the description here. The system 10 provides for feeding quality-controlled, treated fluid to the fluid supply line 14 which is the distribution line that may also be referred to as the main line 14 herein to distinguish it from various other fluid lines to be described throughout this specification. Flow is generally in the direction of the arrow(s) 80. As an alternative to feeding fluid to main line 14, the flow control sub-system 15 may divert fluid, e.g., sub-standard quality fluid to a drain line 19 as described further herein.

An inlet feed line 13 which feeds into treatment unit 12 will be understood as feeding water from any of various sources or combinations of sources (none shown) such as from a tap and/or from one or more treatment (e.g., reverse osmosis (R/O) or deionization (DI)) or pre-treatment devices (e.g., filtration devices (carbon and/or mechanical filter(s) and/or chemical or water softening or like water treatment device(s)), for example, or even intermediate storage tanks (if used) (none shown). Moreover, feed line 13 may also alternatively receive feedback water from the purified water line 14 via a connecting line 17 (shown in dashed lines in FIG. 1) to create a main supply circuit or loop 16.

The fluid system main line 14 is shown having a plurality of connection branches generally designated in FIG. 1 with the reference numeral 18. One or more fluid or water using machines 20 may then be connected through respective branches 18 to the main line 14. In this description particularly of FIG. 1, machines 20 may be considered relatively generically such that they may be understood to represent, for example, one or more dialysis machines, and/or, one or more other types of medical machines, inter alia. As was described hereinabove, it has been known in the art to connect one or more dialysis machines 20 to a single main water supply line 14. Further devices, machines, systems or outlet taps have been known to be similarly connected to a main line 14 in a dialysis setting as well, including, for example, taps for centralized bicarbonate concentrate preparation, dialyzer re-use (or re-processing) machines, dialyzer pre-rinse or dialyzer cleansing devices (e.g., for cleaning a dialyzer prior to use of the dialyzer in a dialysis process, some of the above also sometimes referred to as pre-cleaning devices, herein), and/or pre-rinse sensor or sink cleansing devices. Any such other devices are intended also to be represented interchangeably by the generic reference numeral 25 in FIG. 1. A discrete sub-circuit may also be encompassed within the definition of device/system 25. Water used by either machines or systems 20 or 25 or the like may then be flowed to a drain via each respective drain line 21. This water may alternatively be returned to the inlet of the treatment unit 12, see line 17 in FIG. 1.

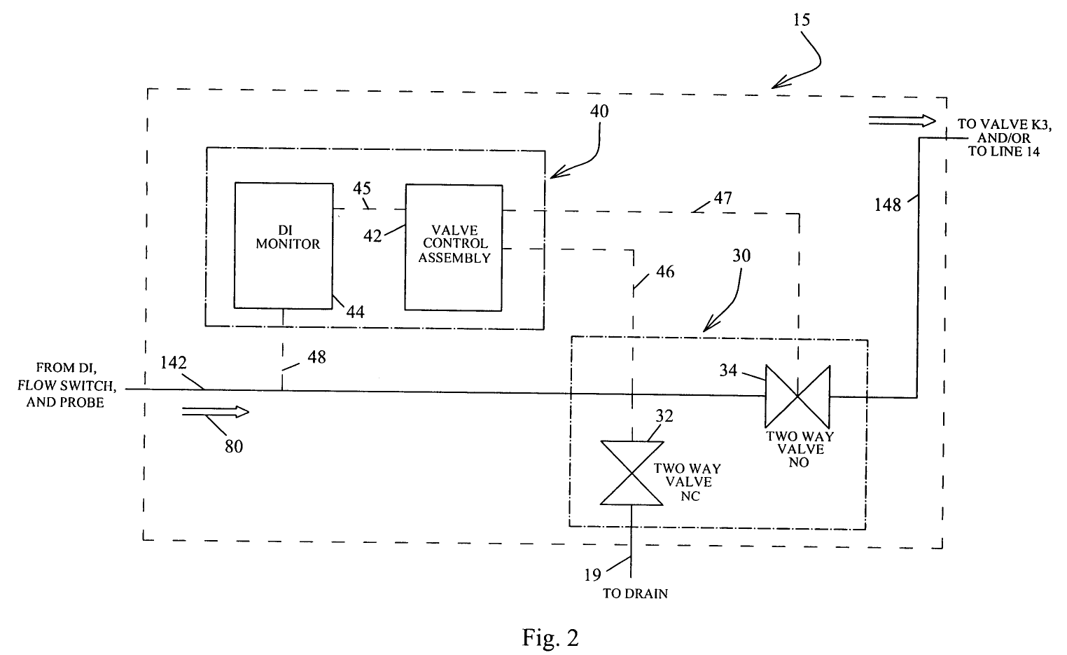

The sub-system 15 of the present invention may be considered as a singular integral unit or as including two (or more) sub-units, e.g., a mechanical or hydraulic unit or sub-unit 30 and an electrical unit or sub-unit 40 as shown schematically in dashed line circles for example in FIG. 2. These sub-units are communicatively connected as will be described below.

Also shown in FIG. 2 is that the hydraulic unit or sub-unit (HU) 30 may include two valves 32 and 34 and plumbing pieces (e.g. PVC or another relatively inert material such as stainless steel or the like (note, non-inert materials may also be used depending upon the application)) for connection of the valves 32, 34 together and with the fluid system 10. The first valve 32 (which may also be referred to as a “Drain” valve) may be a normally closed valve such as a normally closed (NC) solenoid valve that directs water from the fluid system to a drain when triggered or energized (see drain line 19). The second valve 34 (which may also be referred to as a “To Loop” valve) may be a normally open valve such as a normally open (NO) solenoid valve which will turn off flow to the purified fluid distribution system. These valves 32, 34 may be named differently depending on the fluid or water system configuration and system schematic. These two two-way valves 32, 34 may be positioned in a fluid manifold (not separately shown) after the connection to the fluid purification device (e.g., DI tank(s)) 12 (FIG. 1) and after the quality sensor (e.g., DI Monitor) 44. As mentioned, the two valves may be of a solenoid type such that electrical power is used to activate/energize their movement from their normally open or normally closed state to their opposite state. Note, the concept of “triggering” is here intended to encompass the concept of signaling the valve to change state, whether it be from open to close, or vice versa, and regardless of the normal state of the particular valve in question.

Use of such types of valves, and/or the use of two separate valves in a situation such as this may provide a sort of beneficial redundancy and/or fail safe operation whereby if one or the other of the two valves 32, 34 fails, the operation is not compromised. For example, if upon a proper sensor signal, valve 32 fails to open, diversion to drain does not occur, but all flow merely stops (when valve 34 successfully closes) such that no contaminating fluid flows to the main line 14; and similarly, a failure of valve 34 to properly close is likewise not fatal, flow will likely be made to divert to the likely lower resistance of the drain through the successfully opened valve 32. Note, although in one embodiment the valves may be of an electrically powered solenoid type which may be triggered upon energization to open or close contrary to the normal position thereof, other valve types may also alternatively be used herein, though generally being triggered to open or close in response to the electrical control system described below. Thus, here also, triggering can include the signaling to change state regardless the normally opened or closed state of the particular valve.

As mentioned, normally-open (NO) or normally-closed (NC) valves as described may provide one or more convenient advantage in protections against failure. However, other configurations may also provide advantages, for example if both valves are normally-closed, with circuitry provided to power them open. Then a no-flow condition (as may be desired), in either direction could be ensured during any power failure mode. Similarly, in certain applications if may prove desirable to have to normally-open valves operating with power circuit required to close, wherein a complete loss of power could then ensure a full diversion condition with both valves opened and flow proceeding to and through the lower resistance divert line 19.

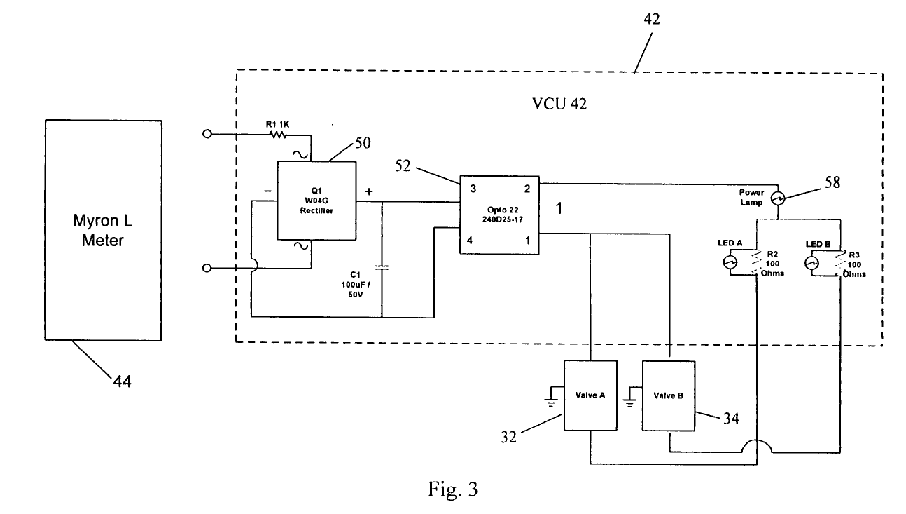

The second unit 40 of system 15 may be or include an electrical valve control unit (VCU) 42 which has circuitry for valve activation (to open or close and/or vice versa), connection terminals, AC power connection and LED indicators for the user. The fluid quality sensor 44 (also referred to as a DI monitor) may in one alternative embodiment (see e.g., FIG. 2), be a part of VCU 42 or in other embodiments, be relatively discrete therefrom as shown in FIG. 3 et al., though still operably connected thereto as described here. Monitor 44 generally provides for sensing a quality parameter through a connection 48 to the fluid line 142 as shown in FIG. 2 and may then provide a signal such as an alarm signal (AC or other powered signal, or mere alarm set of contacts, switches, relays or the like; see below) to the VCU 42 via connection 45 that indicates that the fluid resistivity (or conductivity or other parameter) has changed to an alarm limit value (e.g., reached, dropped below, or raised above the alarm limit). The VCU 42 then activates both of the two-way valves 32, 34 through the respective connections 46, 47. This then opens the flow of the fluid to drain line 19 through the first valve 32, while closing the flow of to the purified fluid loop through the other valve 34 and connection line 148. See FIG. 2.

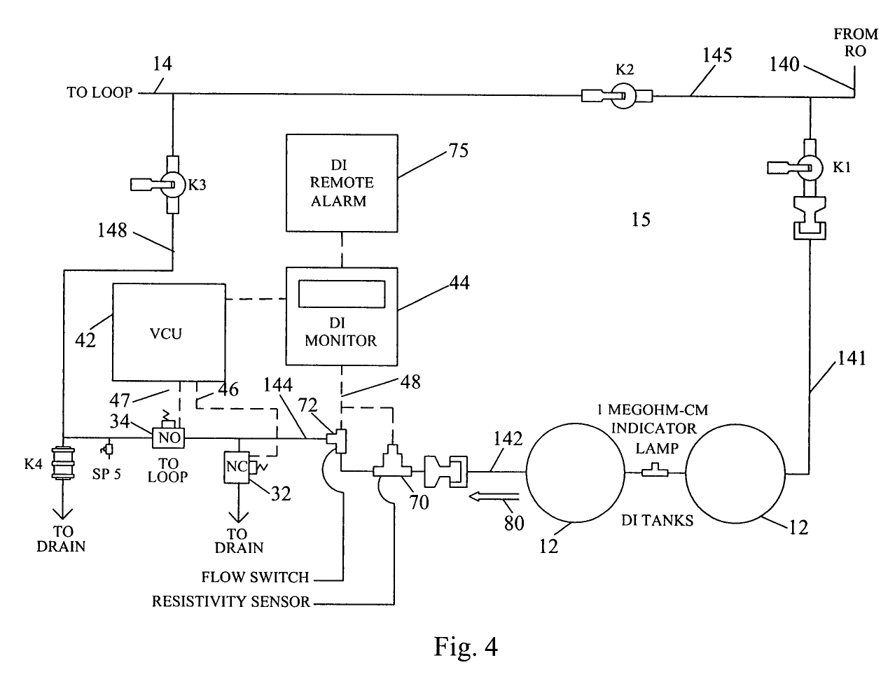

The fluid monitor 44 may provide an alternating current (AC) signal for the signal output on line 45. As shown in more detail in FIG. 3, a rectifier circuit 50 may be disposed inside the VCU 42 to receive the AC signal and provide the direct current (DC) input which may be used (or even may be required) by a solid state relay such as relay 52; which may be an on/off relay. Examples of one embodiment of operating parameters include 6-30 Volts AC (VAC) for an alarm or triggering signal from the fluid monitor 44 (although other voltage inputs in different ranges, dependent for example on different fluid monitor outputs, may be used). Other details of an electrical schematic which may be used in the system 15 are provided in FIG. 3. Such a system 15 may be configured to be used with a water quality monitor such as the Myron L meter indicated generally in FIG. 3 (e.g., model 753-1 DI Monitor), and may use the alarm issued by such a Myron L DI monitor 44 for activation of the valve control circuitry in VCU 42. Myron L meters are examples from but one alternative manufacturer/supplier (the Myron L Company, Carlsbad Calif.), and the invention is not intended to be limited thereto, other alternatives are available and will be later developed as understood in the art. Description of the workings of this and other alternative types of sensors/monitors is set forth below (see description relative to FIG. 4). Such a system 15 may then be used as a means of preventing sub-standard quality DI water from reaching a point of use. In such a use, the present invention system 15 may be referred to a DI Divert to Drain System. A DI water divert system 15 may then be used in water treatment systems such as for dialysis machines (see FIG. 1), however, it may be used in other water or other fluid systems in which a sensor-initiated diversion of fluid flow is desired.

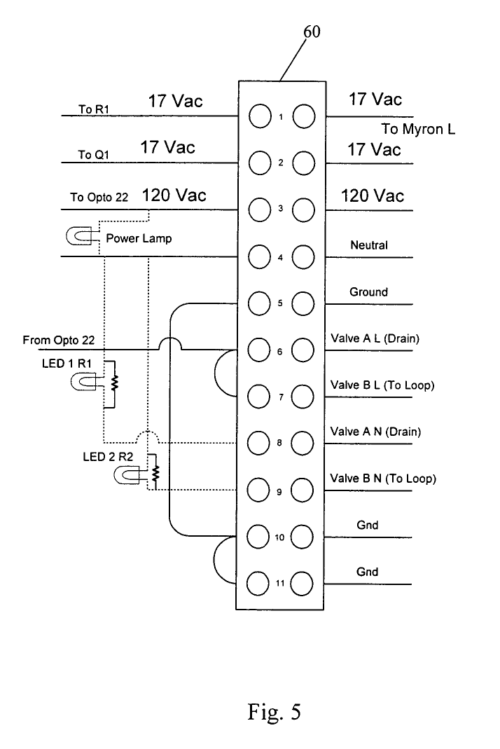

Other electrical features which may be included in or with a VCU 42 are, as shown in FIG. 3, LED sub-circuits 54, 56 for indicating the status of the valves 32, 34 (on or off, open or closed, for example), as well as an optionally used power light circuit element 58. These LED sub-circuits are shown disposed post the valves 32, 34 to show an operator that power (i.e., current flow) has not only been sent to, but has also traveled through the valves 32, 34. Example electrical connections for the elements of VCU 42 are shown in FIG. 5, where connected to the terminal block 60 (which may be located in the VCU 42) are the power and ground wires of the drain valve 32 (power pins 6 and 8, and ground pin 10) as well as the wires of the “To Loop” valve 34 (power pins 7 and 9, and ground pin 11). Also connected hereto may be the alarm wires from the fluid quality monitor 44 (e.g., a Myron L meter) for connection to the VCU 42 (e.g., using pins 1 and 2). Power may then come from the meter 44 for distribution to the valves 32, 34, i.e., power may then be plugged into the VCU 42 via the Meter 44. The power and LED lamps 58, 54 and 56 may thus also be connected as shown in FIG. 5, for example.

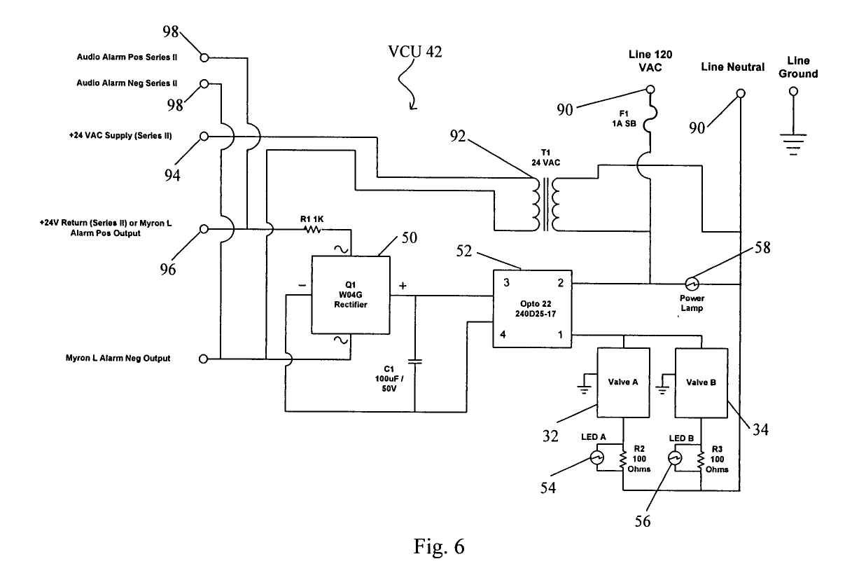

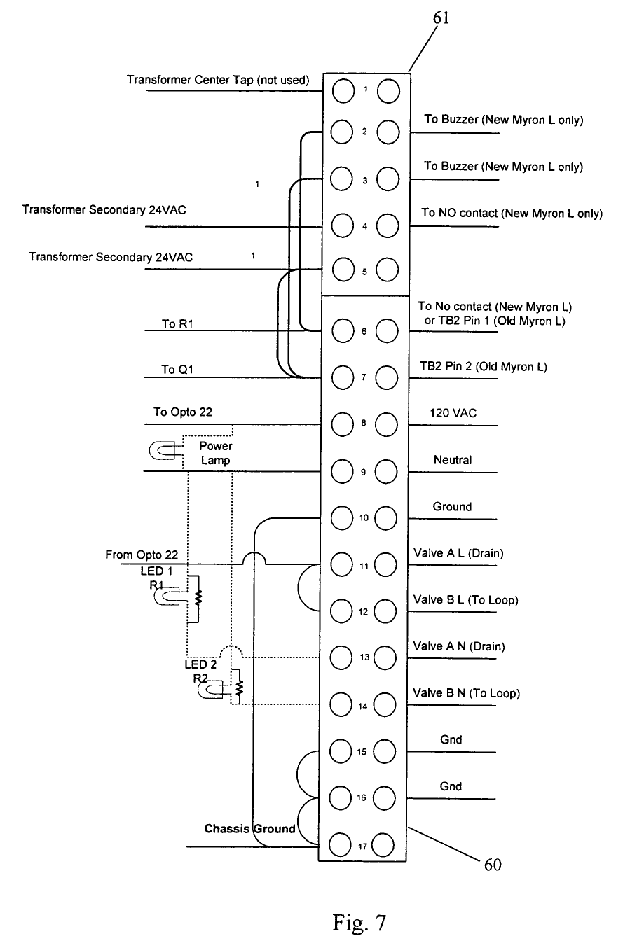

Note, often times, fluid monitors or meters are generally low power (low voltage, low current), whereas, valves such as those used here are more often relatively high power devices, such that the power emitted by a monitor/meter may be insufficient to drive such valves. Thus, in an alternative electrical embodiment as shown in FIG. 6, the power to drive the valves may instead of being supplied by/through the meter 44 as shown and described above, may rather be supplied directly to the VCU 42. Such power may thus also be used to supply a 120VAC line power transformer 92 inside VCU 42. Connections 90 are used to communicate this power to transformer 92 instead of from/through the meter 44. This transformer 92 may then supply power to quality sensor units that may be unable to output an electrical voltage or current during an alarm condition. The VCU can now, in this embodiment supply an electrical voltage to the quality sensor that can be passed through the quality sensor, depending on alarm state, and returned to the VCU to indicate that alarm state. The quality sensor may typically accomplish this through the use of a relay or other electrical switch, or trigger upon the sensing of an alarm or signal condition. This way, a meter 44 which does not supply a power output may be used. Thus, a mere signal or switch indication from an appropriate meter may close a circuit to bring power from transformer 92 out of VCU 42 via lead 94 and then back into the VCU 42 control circuitry via lead 96 to rectifier 50, relay 52 and thence to valves 32, 34 and LEDs 54, 56 and 58. Operation will then proceed in the same general fashion as above. An additional output from VCU 42 may also be used as shown by leads 98 which may provide power to an audio or other alarm (not shown) as may be desired upon the triggering event of the sensor signal to VCU 42. Example electrical connections for the elements of VCU 42 of FIG. 6 are shown in FIG. 7, where connected to the terminal block 60 (which may be located in the VCU 42) is a transformer block 61.

Other electrical (or like) elements of or which may be associated with the electrical sub-system 40 may include a resistivity probe or sensor 70 and/or flow switch 72 (see FIG. 4). These may communicate, as shown, directly with the fluid quality monitor 44, as well as with the fluid flow line 142. Further, as shown in FIG. 4, the VCU 42 may also share the alarm signal of the fluid monitor 44 with a remote alarm assembly 75 which may typically be located in a medical system, e.g., in a dialysis treatment area. Alternatively, the VCU may also provide power for a remote alarm assembly in lieu of, or in conjunction with power output by the fluid monitor for alarm activation. For this reason, a high impedance solid state relay 52 may be preferred in such embodiments to activate the solenoid valves.

In a more detailed depiction of an installation as shown in FIG. 4, for example, the hydraulic connections configuration for a DI Water Drain System 15 may be described as follows. Note, the schematic and valve labeling shown in FIG. 4 is only according to one possible embodiment of numerous alternatives within the scope of this invention. The drain valve 32 may, as shown, be placed after the sensor 70 (close in one embodiment, but not necessarily so), and the to loop valve 34 may then be disposed close (though not necessarily) following (see the flow arrow 80) the drain valve to prevent (when activated/closed) flow to the main fluid distribution loop (see fluid line 14). Other water systems using a system 15 may also follow this general configuration.

The inlet of the drain valve 32 may be through a PVC (in one embodiment) T-fitting in fluid line 144. This line 144 is generally communicatively connected to line 142 which emanates from the fluid treatment unit or DI tanks 12. Typically, there may be a resistivity sensor or other probe 70 (depending upon the type of quality sensor used) and possibly a flow switch 72 (see description below) placed prior to the drain valve 32 (in some embodiments, close thereto, though not necessarily so). The output of the drain valve 32 may be connected to a drain via drain line 19, the drain being capable of handling the fluid flow from the fluid system 15. An appropriate air gap may be used to prevent direct connection of the drain valve 32 to the drain (not shown). The output of the “To Loop” valve 34 may be connected to the purified fluid (e.g., DI water) distribution system 10 (see FIG. 1) via lines 148 and 14 (see FIGS. 2 and 4). In some typical embodiments, there may be a manual flush valve K4 (and/or a sample port SP5) after the To Loop valve 34 to allow the DI tanks 12 to be flushed manually after the To Loop valve 34 has been opened. There may also be one or more valves (see K1, K2 and K3 in FIG. 4) that may be used to isolate the fluid system 15 from the main purified fluid distribution system 10.

Though most fluid quality monitors and/or meters provide only a low power output, an embodiment such as that shown in FIGS. 2-5 may include a DI monitor such as the Myron L (e.g., model 753-1 DI Monitor) introduced above may provide actual power output which may then be directed to the valves 32, 34 and used to energize the valves 32, 34 to open and close respectively. Such a Myron L meter (and like alternatives) provides power output which conventionally is used to provide power to an external often remote alarm system (see alarm 75, in FIG. 4). Nevertheless, other monitors which do not provide output power, as may more typically be the case, at least not power sufficient for energizing one or more valves (e.g., valves 32, 34) may alternatively be used according to a scheme such as that shown and described in FIGS. 6 and 7 (above). A device that emits a signal that corresponds to an alarm condition or a sensed condition at, above or below a pre-selected parametric point is desirable in these alternative embodiments. In such a case, the power for the valves may be supplied from other than the monitor/sensor unit which would instead merely provide an indication or signal or otherwise close the circuit that provides power to the one or more valves 32, 34.

Note also that the monitor or sensor unit used may be of resistivity or conductivity (for DI purposes) or other types depending on the parameter chosen to be monitored. In either case, a sensor (e.g., sensor 70) would be disposed in contact with the fluid to be sensed and have a communication connection (could be wireless) back to the monitor unit (e.g., monitor 44). A flow switch such as switch 72, may alternatively be provided (as may be provided by the monitor manufacturer) to indicate that there is flow in the system. This could be used to prevent a false alarm situation when fluid is present but there is no flow (i.e., the invention loop is not being used). Thus, this could be used to indicate that the system is in use (i.e., flow is moving through the monitor/divert sub-system (an AND condition could be the result, i.e., the monitor may not be allowed to provide a signal unless the quality level is at the established threshold AND there is flow through the subsystem). In some instances then the monitor may have factory pre-set parameter alarm and/or divert and/or flow switch limitations, or these limitations may be made operator selectable at or remotely through the monitor unit 44. These alarm and/or divert and/or flow switch limitations may be identically or discretely set so as to be triggered at the identically same parameter characteristic or at distinctly different parameter characteristic levels. Thus, in a resistivity monitored system, the divert to drain mode of operation may be set at one resistivity level (i.e., diversion would be triggered to occur when the sensor senses this resistivity level), and the alarm may be set to provide an alarm signal to the operator at the reaching of the same or a discretely different resistivity level. A flow switch (if used) could then also be set to switch at one or the other of the same or a further discretely different resistivity level.

In operation, the three LEDs 54, 56 and 58 (see FIGS. 3, 5 and 6) may be arranged on a wall or operator's panel to be visually monitored by an operator. A green-colored (or other desirable color) LED 58 can be used to indicate system power. This LED 58 should always be lit as long as the electrical cord is plugged in and power is applied. The two valve LEDs 54, 56 may be red-colored (or other desirable color) to indicate when the respective valves 32, 34 are electrically energized, and thus activated to divert fluid from the main system 10 and to a drain through line 19.

Testing valve functions may be performed by activating an alarm test or similar function or using a depressible “Press to Test” button on the DI monitor 44 (as included, e.g., on a Myron L model 753 monitor) or other quality sensor. As wired according to the above description the visual alarm on the DI monitor will/should be illuminated (if operating correctly) when the button is pressed. The two valve LEDs 54, 56 on the VCU 42 may then be verified as illuminated (also if operating properly). The two valves 32, 34 may also make an operator audible sound as they are activated. The LEDs incorporate a through the valve continuity check which enables the user to test the electrical integrity of the valves, solenoids (if used), wiring, and valve activation circuitry enabling a more complete test of the system's functionality. Such “through the valve” continuity testing of the circuitry provides for determining whether there is a bad electrical connection, a loose wire or an open (burned out) valve solenoid, or the like, because the corresponding LED will not light up in such a condition. As a point of caution, if both LEDs 54, 56 are not activated when the alarm test function of the quality sensor is activated, the system may not be operating properly and appropriate repairs may need to be completed. Also note that if the alarm test function is activated when the diversion system 15 is in use, flow to the purified fluid distribution system 10 may be interrupted and instead diverted to the drain. Note that with the LEDs disposed after the valves in the electrical current flow scenarios, the LEDs will then light up after power has been delivered to and through the valves, thus they, the LEDs serve as ensurance that the valves have been appropriately provided with power and have not lit up through advantage of a short circuit without actual power reaching the valves.

The present invention may take many forms in distribution or the like. For example, the present invention may involve distribution of a sub-system kit which may be incorporated later in/on an otherwise substantially independent main fluid or water supply system. Advantages in expense and/or automation may be realized here. This makes possible bypassing of a main line portion 145 (FIG. 4) and valve K2 as exemplified by the sub-system 15 in FIG. 4, e.g. Alternatively, the sub-system may be manufactured and distributed as part of an entire fluid supply system which includes the main supply line with or without water purification devices.

As noted, systems of the present invention may be highly beneficial in numerous fluid or water supply systems usually of a quality-controlled nature including those requiring purified water such as in medical applications like dialysis, or may also be useful in potable water treatment, pharmaceutical preparation or electronics manufacturing or other water supply processes. In each of these or other uses, the present invention handles the delivery of fluid or water from and to a main distribution circuit or loop through a sensor/divert sub-system as described herein. It should also be noted that the present invention may be used with or without purification water supply systems.

Also, the present invention may alternatively be directed to other fluid or water handling issues as well. Other types of quality sensors (monitors) which may measure parameters such as but not limited to, temperature, pressure, conductivity, inter alia, may utilize the present invention for diversion of those fluids from the point of use should there ever be a substandard quality of those fluids. For example in the medical and/or dialysis field, heat or other parametric issues may be handled by the present invention. As a particular example, heat sterilization of a main water supply line or loop is known (though not common) in the dialysis water supply field; however, heat sterilization processes may not be compatible with some dialysis or other medical machine operations, and/or excessive temperatures may not be well tolerated. The present invention may effectively isolate such machinery from the main loop upon sensing of the triggering parameter (e.g., heat) so that any sensitive machines are not exposed to any inappropriately high temperature water (or other fluid) flowing through the main loop. Thus, a temperature sensor could be used with or as part of the monitor 44 is such an embodiment. Similarly, it is a common situation that medical machines may be disinfected using a chemical solution or disinfectant, and the present invention can provide an ability to isolate such a chemical from certain equipment connected to the subsystem, if such chemical is sensed as exceeding (positively or negatively) a certain preselected parameter or characteristic such as concentration or causticity or acidity or baseness.

A new and unique invention has been shown and described herein. Numerous alternative embodiments readily foreseeable by the skilled artisan, which were not explicitly described herein are considered within the scope of the invention which is limited solely by the claims appended hereto.

1. A fluid flow control system for use with a fluid flow system for preventing a fluid that has reached a parametric limit from traveling to a point of use; the fluid flow control system including two units; namely,
a valve control unit; and
a hydraulic unit operably connected to the valve control unit;
whereby the hydraulic unit has first and second valves and plumbing pieces to connect the first and second valves to each other and the fluid flow system;
the first valve being a two-way valve that is either closed in a no-flow position or is open to direct fluid from the fluid flow system to drain when signaled to be at the appropriate state to open communication to a drain; and
the second valve is a two-way valve that is either open to flow through to the fluid flow system or may turn off flow to the fluid flow system when signaled to be at the appropriate state to close communication therewith.

2. A system according to claim 1 wherein the parametric limit is a preset alarm limit.

3. A system according to claim 1 wherein the first valve is a solenoid valve.

4. A system according to claim 1 wherein the first valve is a normally closed valve.

5. A system according to claim 1 wherein the first valve is a normally open valve.

6. A system according to claim 1 wherein the first valve is a drain valve.

7. A system according to claim 1 wherein the second valve is a solenoid valve.

8. A system according to claim 1 wherein the second valve is a normally open valve.

9. A system according to claim 1 wherein the second valve is a normally closed valve.

10. A system according to claim 1 wherein the second valve is a to loop valve.

11. A system according to claim 1 wherein the system is used in water treatment systems used for dialysis.

12. A system according to claim 1 wherein the system is used in non-dialysis fluid systems in which a sensor-initiated diversion of fluid flow is desired.

13. A system according to claim 1 wherein the fluid is deionized (DI) water.

14. A system according to claim 1 wherein the system is used for preventing sub-standard quality water from reaching a point of use.

15. A system according to claim 1 wherein the system is configured for use with a water quality monitor.

16. A system according to claim 1 wherein the system is configured for use with a water quality monitor which has an alarm power output, whereby the system uses the alarm power output issued by the water quality monitor for activation of the valve control unit.

17. A system according to claim 1 wherein the system includes a quality monitor and the valve control unit shares a fluid monitor alarm signal with a remote alarm assembly.

18. A system according to claim 1 wherein the system includes a fluid monitor and the fluid monitor provides an AC signal for the alarm output.

19. A system according to claim 1 wherein the system includes a fluid monitor and the valve control unit is connected to a source of power and the fluid monitor provides a signal for the valve control unit to provide appropriate power to one or more of the first and second valves.

20. A system according to claim 1 wherein the valve control unit includes circuitry for valve activation, connection terminals, and LED indicators for the user.

21. A system according to claim 1 wherein the valve control unit includes circuitry for LED indicators for through the valve continuity testing of the circuitry.

22. A system according to claim 1 wherein the system includes a fluid quality monitor and the fluid quality monitor provides an alarm signal to the valve control unit that indicates that a fluid parameter has reached an alarm limit.

23. A system according to claim 1 wherein the system includes a fluid quality monitor and the fluid quality monitor is a resistivity monitor which provides an alarm signal to the valve control unit that indicates that fluid resistivity has reached an alarm limit.

24. A system according to claim 1 wherein the system includes a fluid quality monitor and the fluid quality monitor is a conductivity monitor which provides an alarm signal to the valve control unit that indicates that fluid conductivity has reached an alarm limit.

25. A system according to claim 1 wherein the system includes a fluid quality monitor and the fluid quality monitor is a temperature monitor which provides an alarm signal to the valve control unit that indicates that fluid temperature has reached an alarm limit.

26. A system according to claim 1 wherein the system includes a fluid quality monitor and the fluid quality monitor is a pressure monitor which provides an alarm signal to the valve control unit that indicates that fluid pressure has reached an alarm limit.

27. A system according to claim 1 wherein the valve control unit activates both of the first and second valves which opens the flow of the fluid to drain through one of said first and second valves, while closing the flow of fluid to the main water circuit through the other of said first and second valves.

28. A system according to claim 1 which provides a redundant fail safe wherein one of the first and second valves may fail during an alarm condition and yet provide for restricting the flow of sub-standard fluid away from the fluid flow system.

29. A system according to claim 1 which provides a redundant fail safe wherein one of the first and second valves may fail during a non-alarm condition and yet provide for continuing to allow flow of fluid to the fluid flow system.

30. A system according to claim 1 wherein a high impedance solid state relay is used to activate the valves.

31. A system according to claim 1 wherein a rectifier circuit is disposed inside the valve control unit to provide direct current (DC) input to a solid state relay.

32. A method for diverting a fluid that has reached a preset alarm limit from reaching the point of use; including:
flowing a fluid through a fluid system which includes a flow control system for preventing a fluid that has reached a preset alarm limit from reaching the point of use; the fluid flow control system including two units; namely,
a valve control unit; and
a hydraulic unit operably connected to the valve control unit;
whereby the hydraulic unit has first and second valves and plumbing pieces to connect the first and second valves to each other and the fluid system;
the first valve being a valve that directs water from the fluid flow system to drain when signaled to be at the appropriate state;
the second valve is a valve that when signaled to be at the appropriate state turns off flow through the fluid flow system; and
signaling the opening of the first valve; and the closing of the second valve to divert the fluid from the point of use to a drain.

33. A method according to claim 32 which further includes a step for sensing when the fluid has reached a preset alarm limit.

34. A method according to claim 32 wherein the alarm limit is for sub-standard quality deionized (DI) water.

35. A method according to claim 32 which is used in water treatment systems used for dialysis.

36. A method according to claim 32 in which the valve control unit uses a water quality monitor.

37. A method according to claim 32 in which the valve control unit uses a water quality monitor; whereby water quality is defined by a parameter selected from the group consisting of: resistivity, conductivity, pressure, temperature and flow.

38. A method according to claim 32 in which the valve control unit has a water quality monitor which has an alarm power output and the alarm issues an alarm output which activates the valve control unit.

39. A method according to claim 32 wherein the Valve Control Unit (VCU) includes circuitry for valve activation, connection terminals, AC power connection and LED indicators for the user.

40. A method according to claim 32 wherein the first valve is a normally closed solenoid valve which is connected to a drain.

41. A method according to claim 32 wherein the second valve is a normally open solenoid valve which provides a connection to the fluid flow system.

42. A method according to claim 32 wherein the fluid monitor provides an alarm signal to the Valve Control Unit that indicates that fluid quality has reached the alarm limit.

43. A method according to claim 32 wherein the Valve Control Unit activates both of the first and second valves which opens the flow of the fluid to drain through the first valve, while closing the flow of fluid to the fluid system through the second valve.

44. A method according to claim 32 wherein the Valve Control Unit shares the fluid monitor alarm signal with a remote alarm assembly.

45. A method according to claim 32 wherein the Valve Control Unit shares the fluid monitor alarm signal with a remote alarm assembly and the remote alarm assembly is located in a dialysis treatment area.

46. A method according to claim 32 wherein a high impedance solid state relay is used to activate the first and second valves.

47. A method according to claim 32 wherein the fluid monitor provides an AC signal for the alarm output.

48. A method according to claim 32 wherein a solid state relay and a rectifier circuit are disposed inside the Valve Control Unit, the rectifier providing a direct current (DC) input for the solid state relay.

49. A method according to claim 32 wherein the system includes a fluid quality monitor and the fluid quality monitor provides an alarm signal to the valve control unit that indicates that a fluid parameter has reached an alarm limit and the valve control unit is connected to a source of AC power and thus provides AC power alarm output to power one or more of the first and second valves.

50. A method according to claim 32 wherein the system includes a fluid quality monitor and the fluid quality monitor is a resistivity monitor which provides an alarm signal to the valve control unit that indicates that fluid resistivity has reached an alarm limit.

51. A method according to claim 32 wherein the system includes a fluid quality monitor and the fluid quality monitor is a conductivity monitor which provides an alarm signal to the valve control unit that indicates that fluid conductivity has reached an alarm limit.

52. A method according to claim 32 wherein the system includes a fluid quality monitor and the fluid quality monitor is a temperature monitor which provides an alarm signal to the valve control unit that indicates that fluid temperature has reached an alarm limit.

53. A method according to claim 32 wherein the system includes a fluid quality monitor and the fluid quality monitor is a pressure monitor which provides an alarm signal to the valve control unit that indicates that fluid pressure has reached an alarm limit.

54. A method according to claim 32 wherein the system includes a fluid quality monitor and the fluid quality monitor is a flow monitor which provides an alarm signal to the valve control unit that indicates that fluid flow has reached an alarm limit.

55. A method according to claim 32 wherein the valve control unit activates both of the first and second valves which opens the flow of the fluid to drain through one valve, while closing the flow of fluid to the main water circuit through another valve.
